(19) United States
(12) Patent Application Publication
(10) Pub. No.: US 2009/0114726 A1
(43) Pub. Date: May 7, 2009

(54) METHOD AND DEVICE FOR PROTECTION AND CONTROL OF ORIGINALITY OF PRODUCTS AND THEIR COMPONENTS AND ELECTRONICALLY READABLE CERTIFICATE THEREOF

(76) Inventors: Zhivko Zhelev, Sofia (BG); Arkadiush Zhelev, Sofia (BG)

Correspondence Address: LADAS & PARRY LLP, 26 WEST 61ST STREET, NEW YORK, NY, 10023, US

(21) Appl. No.: 12/300,210

(22) PCT Filed: May 11, 2007
(86) PCT No.: PCT/BG07/00008

§ 371 Date: Jan. 15, 2009

(51) Int. Cl. G06K 5/00

(52) U.S. Cl. 235/454

(57) ABSTRACT

The invention relates to method and device for protection and control of originality of products and their components and electronically readable certificate thereof. Depending on the structure of product (1) an alloying layer (2) is deposited over the product. The layer (2) is affected by a subsequent controlled beam or jet marking carried out by means of a beam (3) depositing a restorable marking (4). In order to control or recover the marking the surface, the conductivity and the structure of the marked part is scanned in the area where the marking is deposited. The acquired image of the encoding elements of the markings is compared with information that contains relevance between the original marking and the encoded restorable elements. The information is recorded in a database as well on the accompanying electronically readable certificate (12) protected by means of a multimedia encrypted marking (13) against manipulation or counterfeit.

### TECHNICAL SCOPE OF THE INVENTION

The invention relates to method and device for protection and control of originality of products and their components and electronically readable certificate thereof.

### BACKGROUND OF THE INVENTION

Methods and devices are known for numbering and control of the originality of the products by means of marking, laser engraving, mechanical numbering, multimedia multi-stage encrypted markings, etc. The prior art methods and devices are complemented with deferent certificates, which common control is carried out by bare eye, tools or automatic readers.

The disadvantages of the above stated methods are that in case of mechanical numbering or laser engraving it is not possible to distinguish the original from the fake one if an exact replica, so called cloning, of the original marking and certificate is done and the multi-stage encrypted marking itself is not immune against erasure or in case a deep removal of the encrypted marking is done it is impossible to determine its uniqueness.

### TECHNICAL DESCRIPTION OF THE INVENTION

The goal of the invention is to create method and device for protection and control of originality of products and their components and electronically readable certificate thereof. More specifically control of production, control of weapons, firearms and their spare parts and ammunitions, automobiles and automotive industry, aircraft industry, machine-building industry and other products for tracking purpose, control of their and of their components originality, proof of their origin and producer as well as control of the originality of their certificate which can be accomplished although the exact replication, imitation, cloning or erasure of the deposited marking is tried to be made.

The goal is achieved by means of the method and device feature with that over the product depending on its structure a thin alloying layer is deposited. During the process of marking, that is carried out by the controlled beam (a laser beam, an electron beam, an ionic beam, etc), because of the raise of the temperature the elements of the alloying layer penetrate deep into the material of the product over which the multi-stage encrypted marking is being recorded and simultaneously alter the structure of the material round and into the area of the marking. By means of the control and the adjustment of the power of the marking beam, the thickness and the type of the alloying layer we can control in such a way the structure's alteration and the depth of the penetration at the specific encoding points of the marking that they will be so deep into the structure of the material of the product deeper than the critical depth where in case of so deep mechanical material removal, i.a. erasure of the marking, the product will be destroyed or its utilization made impossible. The reading and control of so-accomplished markings, that can be restored in case of the attempts of their erasure or manipulation, is carried out by scanning the surface, the conductivity and the structure of the material in the area of the marking or in case of the erasure in the area where the marking was recorded. The acquired image and parameters are processed and then are compared with the parameters of the encoding elements recorded into the database when the original marking was done. The database contains the relation between original marking and the encoding elements in it. If the acquired parameters match those recorded in the database the marking can be restored if it is erased and its originality can be proof. During the marking of the product the relation between the visible original marking and the hidden encoding elements is recorded on the accompanying electronically readable certificate. After that the chip of the certificate and the material of the certificate are marked in the same way with the restorable multi-stage encrypted markings which protect the certificate against manipulation and counterfeit. The certificate then, after its originality is proved by the markings on it, can be utilized in process of control of the marking recorded over the corresponding product as the certificate contains the relation between the visible original marking and hidden encoding elements.

### DESCRIPTION OF THE FIGURES

The invention is illustrated by the following figures:

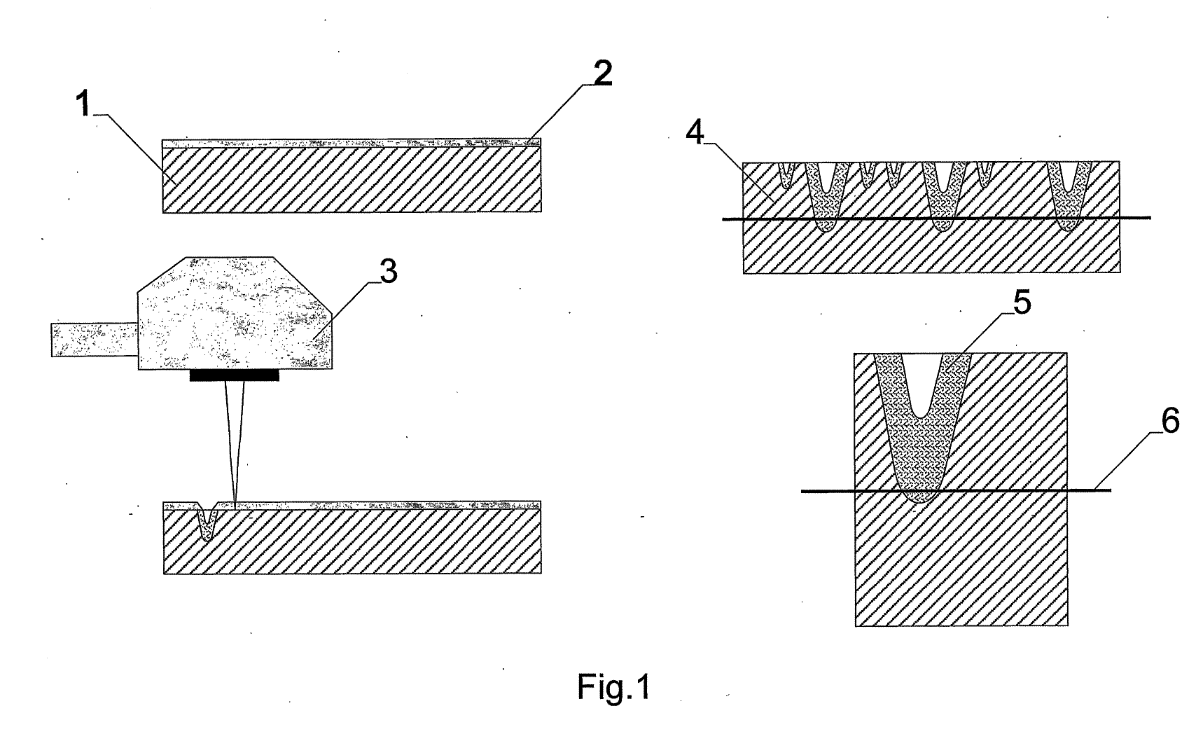

FIG. 1—a method for the deposition of the restorable multi-stage encrypted markings
1. product
2. alloying layer
3. controlled beam (a laser, an electron, an ionic beam, etc.)
4. restorable multi-stage encrypted marking
5. altered structure of the material.
6. critical depth line

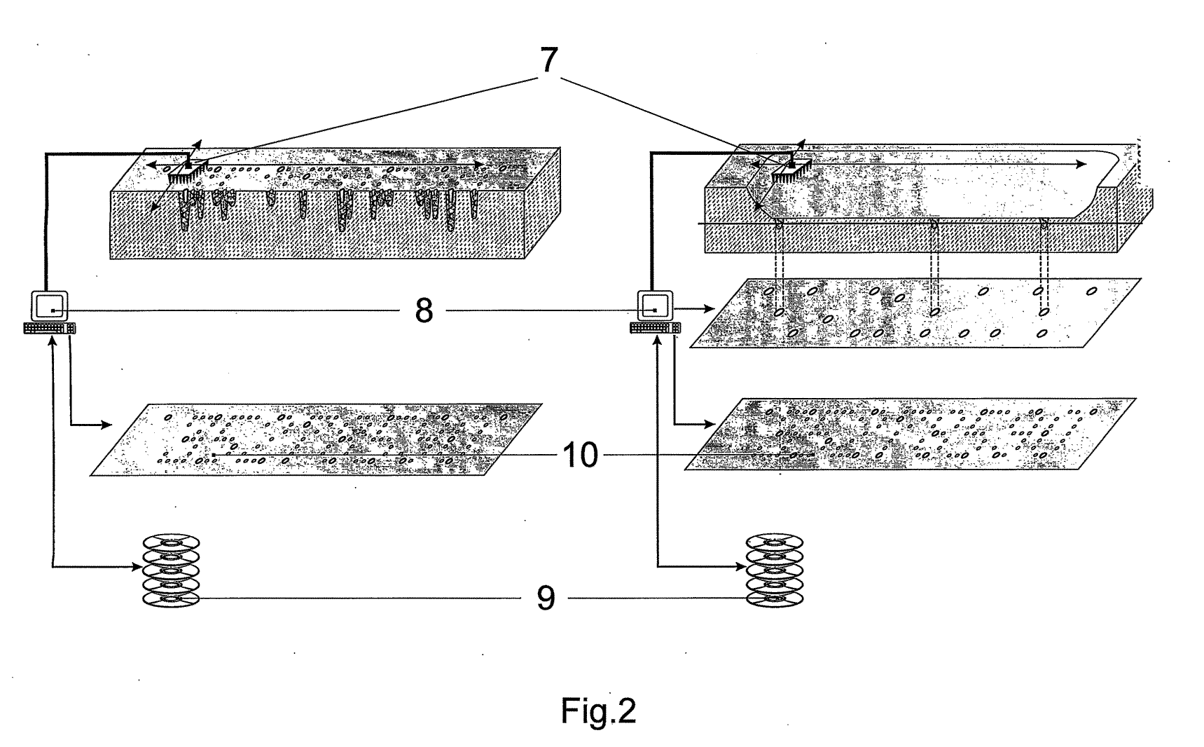

FIG. 2—a method and the device for reading of the restorable multi-stage encrypted markings
7. reader (CCD, AFM, CMOS, etc.)
8. computer
9. database
10. multi-stage encrypted marking

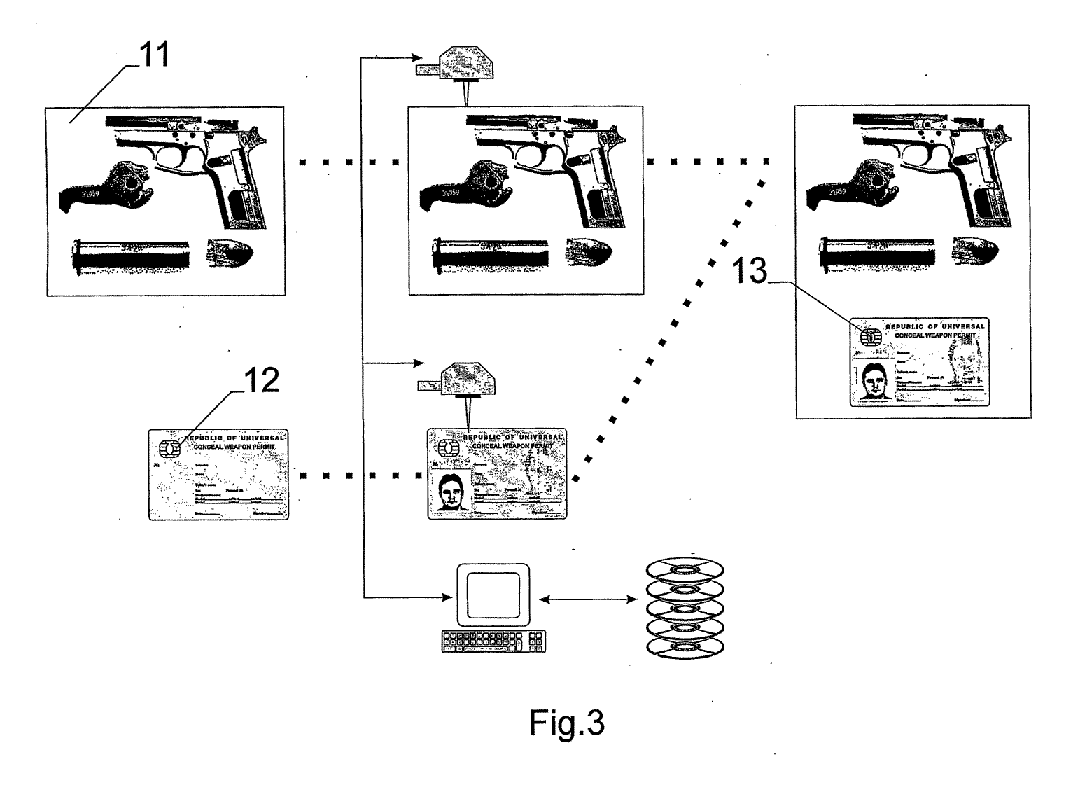

FIG. 3—a method for recording and reading of multi-stage encrypted marking restorable after the erasure or the manipulation for protecting the originality of products and the accompanying certificates.
11. product
12. certificate with the electronic carrier.
13. the restorable multi-stage encrypted marking over the certificate and the electronic carrier.

### PREFERRED EMBODIMENT OF THE INVENTION

Over the product depending on its structure is deposited the thin alloying layer that is deferent for the deferent materials. During the process of marking, that is carried out by the controlled beam (a laser beam, an electron beam, an ionic beam, etc), because of the raise of the temperature the elements of the alloying layer penetrate deep into the material of the product over which the multi-stage encrypted marking is being recorded and simultaneously alter the structure of the material round and into the points of the marking. By means of the control and the adjustment of the power of the marking beam, the thickness and the type of the alloying layer, the structure's alteration of the material and the depth of the penetration are controlled at the specific encoding points of the marking in such a way that they will be so deep into the structure of the material of the product deeper than the critical depth where in case of so deep mechanical material removal, i.a. erasure of the marking, the product will be destroyed or its utilization made impossible. The reading and control of so-accomplished markings, that can be restored in case of the attempts of their erasure or cloning, is carried out by scanning with the reader (CCD, AFM, CMOS or other) the surface, the conductivity and the structure of the material in the area of the marking or in case of the erasure in the area where the marking was recorded. The so-acquired image and parameters are eventually processed and then are compared with the parameters of the encoding elements recorded into the database when the original marking was done. The database contains the relation between original marking and the encoding elements in it. If the acquired parameters match those recorded in the database the marking can be restored if it is erased and its originality can be proof. During the marking of the product the relation between the visible original marking and the hidden encoding elements is recorded on the accompanying electronically readable certificate. After that the chip of the certificate and the material of the certificate are marked in the same way with the restorable multi-stage encrypted markings which protect the certificate against manipulation and counterfeit. The certificate then, after its originality is proved by the markings on it, can be utilized in process of control of the marking recorded over the corresponding product as the certificate contains the relation between the visible original marking and hidden encoding elements.

1. Method for deposition of multi-stage encrypted markings restorable after attempts for their erasure or manipulation, which protect the originality of the product and, characterized in that over the product (1), depending on its structure, is deposited the thin alloying layer (2) and during the subsequent controlled beam or jet marking by the beam (3) that records the multi-stage encrypted marking (4) in such a way that the alloying layer and the beam fusion alter the structure of the material (5) deeper than the critical depth (6) at which in case of so deep mechanical material removal of the marking, the product will be destroyed or its utilization made impossible.

2. Method for reading of the of multi-stage encrypted markings restorable after attempts for their erasure or manipulation, which protect the originality of the product, characterized in that the surface, the conductivity and the structure of the material in the area of the marking or in case of the erasure in the area where the marking was recorded are scanned and the acquired image and parameters of the encoding elements of the marking are compared with the parameters of the encoding elements recorded into the database, that contains the relation between the original marking and the encoding elements in it when the original marking was done, and if the acquired parameters match those recorded in the database the marking is restored and its originality is proved.

3. Device for reading of the of multi-stage encrypted markings restorable after attempts for their erasure or manipulation, which protect the originality of the product according to claim (2), characterized in that the marking or the place, where the marking is recorded, is scanned by the reader (7) connecting to the computer (8) that processes the received information and compares it with the information in the database (9) in order to verify or restore the original marking (10).

4. Method for recording and reading of multi-stage encrypted markings restorable after attempts for their erasure or manipulation, which protect the originality of the product, characterized in that over the product (11) is deposited the multi-stage encrypted marking and over the accompanying certificate with the electronic carrier (12) and over the database is recorded the relation between the visible marking and the encoded elements followed by the recording of the multi-stage encrypted marking (13) over the electronic carrier in order to prevent the manipulation of the data recorded on the electronic carrier and the counterfeit of the certificate and during the subsequent reading it is verified the originality of the marking of the product after the verification of the electronic carrier and the verification of the multi-stage encrypted marking over the product is carried out according to claim (2) but the utilized database is one recorded over the electronic carrier of the certificate.
